(19) United States
(12) Patent Application Publication
(10) Pub. No.: US 2009/0050093 A1
(43) Pub. Date: Feb. 26, 2009

(54) Twin Ignition System

(76) Inventor: Peter William Petersen, Arlington Heights, IL (US)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 12/172,311

(22) Filed: Jul. 14, 2008

Related U.S. Application Data
(63) Continuation-in-part of application No. 11/700,454, filed on Jan. 31, 2007, now Pat. No. 7,405,492.

(51) Int. Cl. F02N 17/00

(52) U.S. Cl. 123/179.5; 123/406.53

(57) ABSTRACT

A twin ignition system for automotive vehicles and the like is disclosed and claimed. Ignition system #1 comprises a known ignition system which allows electrical access to the engine starter, and allows full function of all facilities with which the vehicle is equipped. Ignition system #2 has its own subsystems which can be set to control vehicle speed and/or other vehicle operating parameters. Each system can be accessed by a key which does not allow access to the other ignition system.

### CROSS-REFERENCE TO RELATED APPLICATIONS

Application Ser. No. 11/700,454, filed Jan. 31, 2007, the disclosure of which is hereby incorporated by reference herein.

### BACKGROUND OF THE INVENTION

Field of the Invention

This invention relates to a multiple ignition system for a vehicle.

Therefore, it is an object of this invention to provide an improvement which overcomes the aforementioned inadequacies of the prior art devices and provides an improvement which is a significant contribution to the advancement of the vehicle ignition system art.

Another object of this invention is to provide a multiple ignition system for a vehicle, comprising a power source, a starter motor, governing means for signaling or restricting operation of the vehicle circuitry under predetermined circumstances, a keyed-ignition system electrically connected between the power source and the starter motor, a first key which interconnects with the keyed-ignition system and a second key which interconnects with the keyed-ignition system.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

My invention is a system that would give society and the automotive industry more control over teen age (or other) drivers who may be of restricted capacity or capability (see explanation below). The invention is what I term a “twin ignition system.

In a preferred embodiment, the “twin ignition system” would entail a vehicle having two separate ignition systems under the hood. At present, most all cars have one box that allows full function of all facilities with which the vehicle is equipped. This is “Ignition Systems #1.” This remains as it is. For special circumstances, however, we have “Ignition System #2.” As would be evident to a person skilled in the art, the multiple ignition systems described herein could be implemented as a single box placed under the hood (or elsewhere) in a vehicle.

Ignition System #2 has its own subsystems which can be set to control m.p.h. (speed) or other vehicle operating parameters, including by example only, car audio system (such as a radio, CD player, or other audio device) and car video system (such as video players, video games, and other entertainment devices). This system #2 can be configured to limit the maximum speed that the vehicle may travel. This maximum speed would be determined by law and would be required for use by teenage or other new drivers or others as determined by law (such as reckless drivers or those on driving probation). The system could also be configured to deny engine starts and/or vehicle operations to those who have access to Ignition System #2, but who are impaired by alcohol or other substances, or who are legally or otherwise restricted to certain routes or areas of travel.

Each ignition system would have its own key and neither key would activate the other system. The object of “Ignition System #2” is to give new drivers a chance to become accustomed to handling a car at different speeds up to the speed limit and driving in traffic in a responsible manner or to restrict impaired drivers to safe driving parameters.

One possible feature of this #2 ignition system is that a notification “system” would illuminate. For example, one visible light could be situated in the front and one in the back of the car. Other drivers would recognize that the red light indicates a “learner” is driving, and that added respect or caution may be required. Other indicia could be used. Police would also pay special attention, if the car is being driven erratically.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a schematic drawing of the main elements of this novel and inventive system;

FIG. 2 is a schematic drawing of an automobile having an example of the invention installed in it; and

FIG. 3 is a schematic drawing of a preferred embodiment of the present invention.

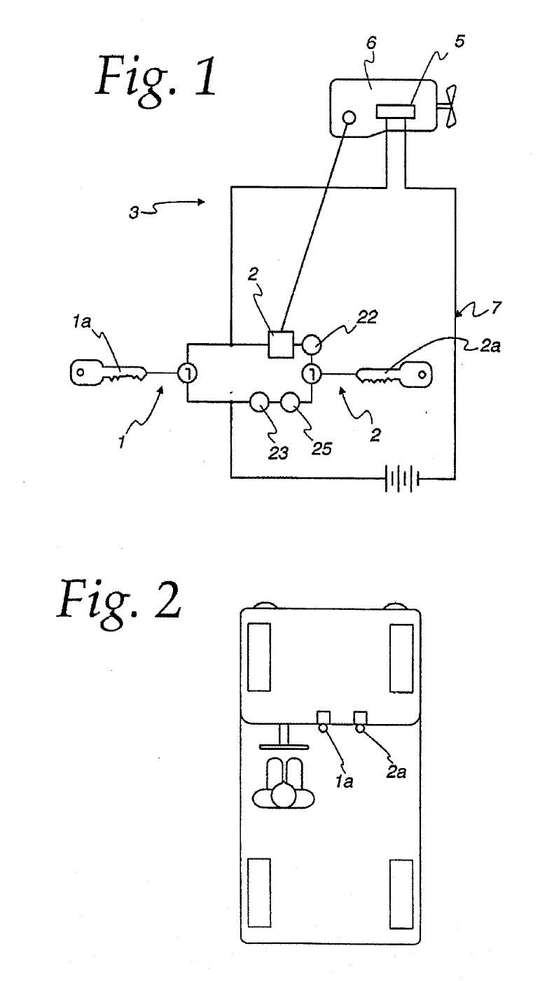

Similar reference characters refer to similar parts throughout the several views of the drawings.

### DETAILED DESCRIPTION OF THE PREFERRED EMBODIMENT

It is a feature of the invention that the invention can be constructed by connecting known parts or subsystems in an appropriate circuit to provide the surprising and highly useful effects alluded to above. In the specific embodiment suggested in the drawing, the alternate ignition systems 1 and 2 are connected in parallel with one another within a known engine starter system 3, which comprises a battery 4 or other power source, and a starter motor 5 or equivalent device which is mounted upon and connected to a conventional automotive engine 6. The precise wiring 7 can be of any known type.

Ignition system 1 can be conventional, and requires only a conventional key la to start the engine and operate the vehicle without restriction. Key la can be kept and used by careful, unimpaired, experienced drivers.

Ignition system 2, however, cannot be engaged or accessed by key la, but only by key 2a. Key 2a can be given to a student driver, an inexperienced driver, or driver who is or might become impaired in some way. As illustrated in the schematic diagram, ignition system 2 can include an engine or vehicle speed governor 21, and/or an alcohol or impairment sensor 22 and/or special warning or caution lights 23, any of which can be connected in electrical series or otherwise with ignition system 2. The caution lights 23 can be mounted on the outside of the vehicle or otherwise located so as to notify other drivers or law-enforcement personnel that an inexperienced or restricted driver is operating the vehicle.

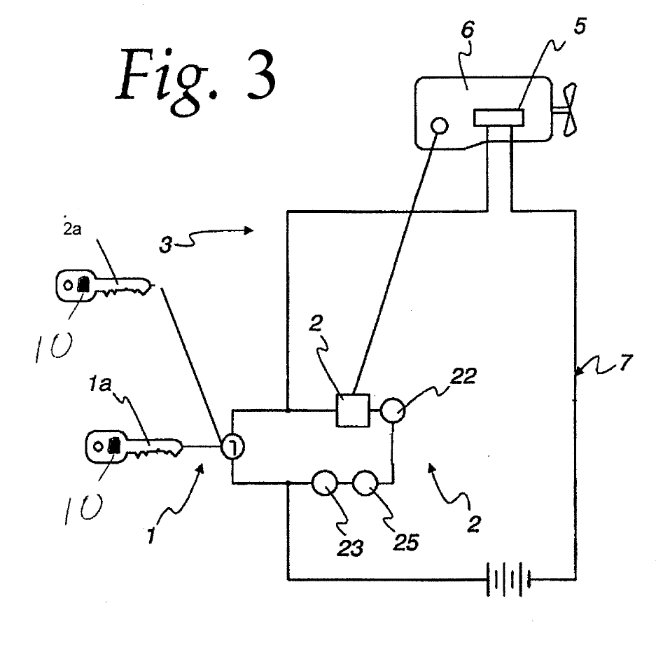

As shown in FIG. 3, key la and key 2a could be implemented as a conventional key which includes a microchip 10 or other controller means embedded, installed, housed, or otherwise placed into the conventional key. For instance, key la and key 2a could each be conventional keys for operating a vehicle whereby each key contains a microchip, with the difference being the logic programmed into the microchip of key 2a informs the ignition system of the vehicle of the limiting characteristics associated with this restricted key.

In another embodiment, sensors could be used throughout the vehicle to disable certain functionalities when certain conditions are detected. For example, when the vehicle is being operated with the restricted key 2a, a sensor could be used to detect whether a passenger is present in the vehicle. Detecting such a passenger, the system may further limit the functionality of the vehicle, such as by disabling the engine, or any other limiting function that may be desired.

As another example, a sensor could be used to detect the weight of a passenger in the vehicle. If a passenger in the rear seat, for instance, were below a certain weight threshold, indicating the passenger was likely a child, operation of the vehicle restricted key 2a might be disabled so as to prevent a restricted driver from operating the vehicle with a young child in the back. Similarly, the vehicle circuitry which enables the rear passenger's window to move up and down might be disabled, thus preventing the child passenger from moving his or her window.

In many geographical areas, judicial traffic courts or medical facilities are empowered to restrict drivers license holders to a specific route of travel or specific geographical area. For example, persons convicted of drunk driving may be permitted by a traffic court to travel only along certain routes between the drivers license holder's residence and place of work. In other cases, medical patients may be restricted by a doctor's orders to driving privileges to be exercised only within a particular city or certain county. To implement these restrictions in accordance with one aspect of the invention, a programmable Global Positioning System 25 can be wired into the circuitry 3. This GPS system 25 can be preprogrammed with one or more discreet and particular routes of vehicle travel; and/or it can be preprogrammed so that, if the GPS system 25 senses that the vehicle has deviated from the preprogrammed area or route of travel by more than a nominal amount, the GPS system 25 opens the ignition switch circuitry 2 so as to shut off the engine 6 and consequently halt vehicle movement.

It will be apparent to those skilled in the art that alternate embodiments of the circuitry and alternate subsystems can be employed without deviating from the invention.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A multiple ignition system for a vehicle, comprising:
a power source;
a starter motor;
governing means for signaling or restricting operation of the vehicle circuitry under predetermined circumstances;
a keyed-ignition system electrically connected between the power source and the starter motor;
a first key which interconnects with the keyed-ignition system, such that the vehicle is fully functional when operated using the first key; and
a second key which interconnects with the keyed-ignition system and the governing means, such that the vehicle is not fully functional when operated using the second key.

2. The system of claim 1 wherein the governing means signals or restricts operation of the vehicle circuitry when the vehicle is operated with the second key.

3. The system of claim 1 wherein the governing means includes a vehicle speed governor.

4. The system of claim 1 further comprising:
an audio system.

5. The system of claim 4 wherein the governing means disables the audio system.

6. The system of claim 4 wherein the governing means reduces the capability of the audio system.

7. The system of claim 1 further comprising:
a video system.

8. The system of claim 7 wherein the governing means disables the video system.

9. The system of claim 7 wherein the governing means reduces the capability of the video system.

10. The system of claim 1 further comprising:
a plurality of sensors wherein the sensors detect the presence of at least one passenger in the vehicle.

11. The system of claim 10 wherein the governing means receives information from at least one sensor.

12. The system of claim 11 wherein the governing means signals or restricts operation of the vehicle circuitry based upon the information received from the at least one sensor.

13. A multiple ignition system for a vehicle, comprising:
a power source;
a starter motor;
governing means for signaling or restricting operation of the vehicle circuitry under predetermined circumstances;
a keyed-ignition system electrically connected between the power source and the start motor;
a key comprising a microchip wherein the microchip communicates with the governing means.

14. The system of claim 13 wherein the microchip is encoded with information used by the governing means to signal or restrict operation of the vehicle circuitry.

15. The system of claim 13 wherein the governing means includes a vehicle speed governor.

16. The system of claim 13 further comprising an audio system wherein the governing means signals or restricts the audio system.

17. The system of claim 13 further comprising a video system wherein the governing means signals or restricts the video system.

18. The system of claim 13 further comprising:
a plurality of sensors wherein the sensors detect the presence of at least one passenger in the vehicle.

19. The system of claim 18 wherein the governing means receives information from at least one sensor and the governing means signals or restricts operation of the vehicle circuitry based upon the information received from the at least one sensor.

20. The system of claim 18 wherein at least one sensor detects the weight of at least one passenger in the vehicle.
